(19) United States
(12) Patent Application Publication
(10) Pub. No.: US 2026/0210010 A1
(43) Pub. Date: Jul. 23, 2026

(54) AEROGEL INFUSED NON-WOVEN COMPOSITES FOR USE IN BUILDING ENVELOPE INSULATION

(71) Applicant: CARLISLE CONSTRUCTION MATERIALS, LLC, Carlisle, PA (US)

(72) Inventors: Mikhail GELFER, Mechanicsburg, PA (US); Jay THAKKAR, Mechanicsburg, PA (US)

(73) Assignee: CARLISLE CONSTRUCTION MATERIALS, LLC., Carlisle, PA (US)

(21) Appl. No.: 19/453,386

(22) Filed: Jan. 20, 2026

Related U.S. Application Data
(60) Provisional application No. 63/748,102, filed on Jan. 22, 2025.

(51) Int. Cl. D04H 1/52; B32B 5/02; B32B 5/12; B32B 5/26; B32B 37/10; B32B 37/14; B32B 37/24; B32B 38/00; D04H 1/4374

(52) U.S. Cl. CPC D04H 1/52; B32B 5/022; B32B 5/12; B32B 5/266; B32B 37/1027; B32B 37/144; B32B 37/24; B32B 38/0004; D04H 1/4374; B32B 2260/023; B32B 2262/0269; B32B 2262/101; B32B 2262/108; B32B 2262/16; B32B 2264/1021; B32B 2264/1024; B32B 2264/2031; B32B 2305/28; B32B 2307/304; B32B 2307/3065; B32B 2315/08; B32B 2315/14; B32B 2377/00; B32B 2419/00; D10B 2401/04; D10B 2505/20

(57) ABSTRACT

A method of making an aerogel insulation material for use in building insulation, by: (a) producing short fibers with attached aerogel particles; (b) depositing the short fibers onto a continuously moving fiber web; (c) crosslapping the continuously moving aerogel-embedded fiber web back and forth on top of itself to produce a layered aerogel-embedded fiber web; (d) passing the layered aerogel-embedded fiber web through a belt press to compress the layered aerogel-embedded fiber web into a stable compressed composite; and then (e) cutting or rolling the stable compressed composite into desired sizes.

### RELATED APPLICATION

The present application claims priority to U.S. Provisional Patent Application Ser. No. 63/748,102, of same title, filed Jan. 22, 2025, the entire disclosure of which is incorporated herein by reference in its entirety for all purposes.

### TECHNICAL FIELD

The present invention relates to aerogel-based building insulation materials.

### BACKGROUND OF THE INVENTION

Current polyiso rigid foam insulation materials used in building roofs typically have an R value of 5.7 per inch. As a result, building owners need to purchase 4 or more inches of thickness of these materials to achieve an R-20 value as required by U.S. building codes.

Aerogel based insulation, on the other hand, holds the promise of an R value of 10 per inch and even above. As a result, a thinner layer of aerogel-based insulation can be used in a building roof or wall as compared to rigid polyiso foam insulation to achieve the same insulation effect. Thinner insulation layers are always desired as they have reduced installation costs. Such reduced costs occur due in part to reduced adhesive and mechanical fastening costs.

Unfortunately, aerogel insulation has weak mechanical properties. For example, although standard polyiso insulation has a compressive strength of 20 to 25 psi, solid aerogel insulation may have a compressive strength of less than 10 psi. As a result, aerogel insulation is fragile and can easily be damaged or destroyed in usage. Instead, what is desired is an aerogel insulation system for a roof or building wall that is thin yet is also strong and not easily damaged.

A common approach for improving mechanical strength and structural integrity of aerogels is to introduce fibrous support into the aerogel (i.e.: manufacturing fiber supported aerogel composites). Fiber reinforced aerogel composites have been extensively described in academic and patent literature. Fiber supported aerogel composites are manufactured by depositing aerogels particles on a fiber bed or embedding the fiber bed into an aerogel matrix.

Currently used techniques for the manufacturing of fiber aerogel composites mostly fall into the following two categories:
1) Composites made from pre-formed aerogel (i.e. a slurry deposition process). In this process, the aerogel is dispersed in a volatile organic solvent forming a slurry, depositing it over the fiber bed. The solvent may contain dissolved adhesive to improve binding between aerogel and supported fibers. The fiber aerogel composite is then formed when the solvent is evaporated.
2) In-situ synthesis process in which a fibrous network is embedded within an aerogel matrix. Such in-situ methods typically include immersing the fiber preform into a sol-gel solution to ensure that the aerogel precursor fully infiltrates the fibrous matrix or coat fibers. Next, controlled gelation and hydrophilization steps are carried out. Alternatively, loose fibers can be embedded in silica aerogels as an effective way to improve their mechanical strengths and reduce breakage and volatilization.

At sufficiently high loads of aerogel (>80 wt %) fiber supported aerogel composites (aerogel mats) achieve R>10. In addition, the reinforcement provided by the fiber particles compensates for poor mechanical properties of a bulk aerogel and also reduces the shedding of aerogel particles. Unfortunately, even in fiber reinforced systems, the shedding of aerogel particles still remains a major problem. These breakaway particles create a health hazard. In addition, the detachment of the aerogel particles from the fiber support during handling creates heat bridges degrading the R-value of the material.

What is now desired is a way to make building insulation materials from aerogel while preventing the shedding or release of the aerogel particles. It is important to prevent the release of the aerogel particles both during the manufacturing process itself and also afterwards such that the aerogel particles remain trapped in the building insulation material during its long use in the roof or walls of a building.

### SUMMARY OF THE INVENTION

The present invention provides an insulation product comprising a non-woven fiber composite which may contain cross-lapped polymeric webs filled with an aerogel material having reinforcement scrim layers that may be made from glass fiber. Along with aerogel-loaded layers, the composite product may contain aerogel-free fiber layers designed to trap loose particles. The present invention optionally includes facers that further reduce aerogel particle shedding and facilitate the handling of the building insulation material. The present invention preferably also comprises a method of manufacturing this building insulation material using a carding and thermo-pressing processes.

In preferred aspects, the present invention provides an aerogel insulation material for use in building insulation made from any of the following preferred method steps described herein. In preferred aspects, the present method of making an aerogel insulation material for use in building insulation, comprises: (a) producing a supply of short fibers having aerogel particles attached thereto; (b) providing a continuously moving fiber web; (c) depositing the short fibers having aerogel particles attached thereto onto the continuously moving fiber web to produce an aerogel-embedded fiber web; (d) crosslapping the continuously moving aerogel-embedded fiber web back and forth on top of itself to produce a layered aerogel-embedded fiber web; (e) passing the layered aerogel-embedded fiber web through a belt press to compress the layered aerogel-embedded fiber web into a stable compressed composite; and then (f) cutting or rolling the stable compressed composite into desired sizes. Optionally, the stable compressed composite may be heated prior to cutting or rolling it into desired sizes.

In preferred aspects, the short (or micro-) fibers are 10-200 mm in length and made of glass or polymer. Preferably, the aerogel particles comprise 70% or more of the weight of the aerogel-embedded fiber web.

The present method may optionally further comprise: (a) placing a first aerogel-free fiber web on top of the stable compressed composite, and (b) placing a second aerogel-free fiber web underneath the stable compressed composite. These first and second aerogel-free fiber webs may be made from mineral or glass fibers or from a high-performance polymer including an aramid and may optionally be thermo-pressed onto the stable compressed composite. In addition, the present method can optionally include: (a) placing a first facer on top of the first aerogel-free fiber web; and (b) placing a second facer underneath the second aerogel-free fiber web. These first and second facers may be adhered to the first and second aerogel-free fiber webs, respectively. The first and second facers may be made from craft paper, polypropylene, PET, polycarbonate, polyethylene, polyurethane, PVC, or an aramid. The fiber web may be made from polymer-based fiber, including but not limited to polypropylene, PET, polyethylene.

The supply of short fibers having aerogel particles attached thereto may optionally be produced by a sol-gel process with the aerogel particles initially being in a powdered form. The aerogel particles may be a silica aerogel, a zirconia oxide aerogel, or a silica carbide aerogel. The supply of short fibers having aerogel particles attached thereto may further comprise a low density/lightweight binder or a flame retardant.

In preferred aspects, the present method discloses a process for creating a fiber-reinforced aerogel composite material with a high aerogel particle content (70-80%) by weight. The composite, designed for insulation and lightweight structural applications, combines the benefits of aerogel's thermal properties with the structural support of fiber reinforcement. The process preferably involves carding and overlapping fiber layers, embedding aerogel particles via a hopper, and using a belt press to consolidate the layers into a stable composite. In accordance with the present invention, adding additional aerogel-free fibrous layers over the aerogel-infused layer(s) helps to reduce particle shedding. Individual fibrous layers may be connected to one another via needle-puncturing, hydro-entanglement, and thermos-forming processes.

### BRIEF DESCRIPTION OF THE DRAWINGS

FIG. 1 is an illustration of a carding and deposition process for making an aerogel-embedded fiber web.

FIG. 2. Is an illustration of a system for cross-lapping the aerogel-embedded fiber web to make a layered aerogel-embedded fiber web.

FIG. 3 is an illustration of passing the layered aerogel-embedded fiber web through a belt press to compress the layered aerogel-embedded fiber web into a stable compressed composite.

FIG. 4 is a close-up sectional elevation view of the structure of the layered composite between two aerogel-free fiber webs which are in turn disposed between a top and bottom facer.

### DETAILED DESCRIPTION OF THE DRAWINGS

The present invention sets forth a method of making an aerogel insulation material for use in building insulation, comprising:
producing a supply of short fibers having aerogel particles attached thereto;
providing a continuously moving fiber web;
depositing the short fibers having aerogel particles attached thereto onto the continuously moving fiber web to produce an aerogel-embedded fiber web;
crosslapping the continuously moving aerogel-embedded fiber web back and forth on top of itself to produce a layered aerogel-embedded fiber web;
passing the layered aerogel-embedded fiber web through a belt press to compress the layered aerogel-embedded fiber web into a stable compressed composite; and then
cutting or rolling the stable compressed composite into desired sizes.

First, the supply of short fibers having aerogel particles attached thereto is produced. This may optionally be done a sol-gel process. The short fibers are preferably 10-200 mm in length and may be made of glass or polymer. The aerogel particles may be supplied in a powdered form, and may optionally be a silica aerogel, a zirconia oxide aerogel, or a silica carbide aerogel. In optional aspects, the supply of short fibers having aerogel particles attached thereto further comprise a low density/lightweight binder and/or a flame retardant.

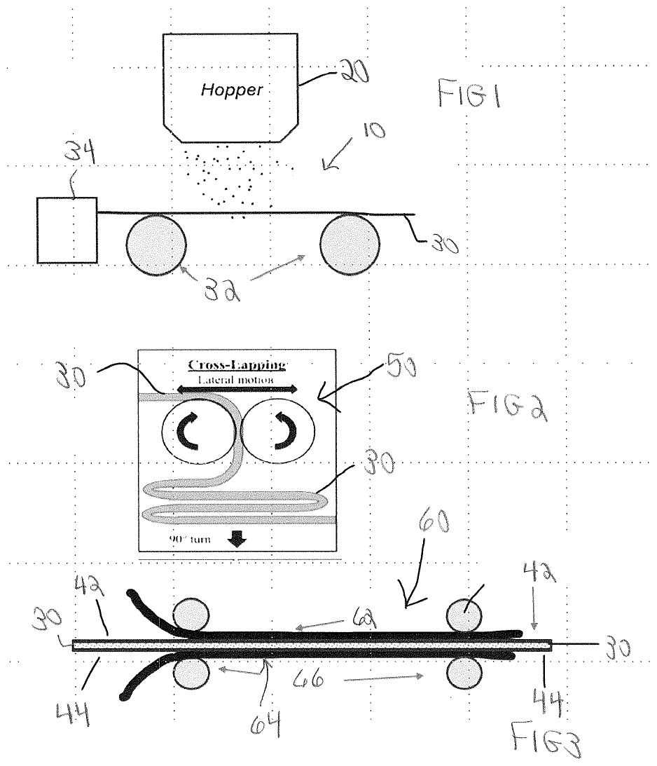

FIG. 1 is an illustration of a carding and deposition process for making an aerogel-embedded fiber web. At this step, short fibers having aerogel particles attached thereto 10 are deposited by a hopper 20 onto a fiber web 30 as it the fiber web 30 is moved therebelow by a carding machine comprising rotating cylinders 32 (with the fiber 30 originating from a fiber extrusion die 34). Note: the present carding machine illustration is shown simplified for clarity. Typical carding machines have many different rollers and components. In operation, the carding machine disentangles, cleans and intermixes fibers to produce a continuous web for subsequent processing. Carding machines pass fibers between differentially moving surfaces covered with “card clothing”, a firm flexible material embedded with metal pins which breaks up unorganised clumps of fiber and then aligns the individual fibers to be parallel with one another. The fiber web 30 is preferably made from polymer-based fiber, including but not limited to polypropylene, PET, or polyethylene.

Preferably, the aerogel particles comprise 70% or more of the weight of the aerogel-embedded fiber web. More preferably, the aerogel particles comprise 70% to 80% of the weight of the aerogel-embedded fiber web.

As seen in FIG. 1, feed fiber material 30 is preferably a loose fiber material (e.g., polyester, cellulose, or other suitable fibers) that is fed into the carding machine via a feeding roller. The carding machine then aligns and disentangles the fibers, creating a thin, continuous fiber web 30. This web will serve as the structural layers in the final composite.

Hopper 20 contains the aerogel particles (which have already been attached to the short fibers). As the fiber web 30 exits the carding machine, aerogel particles are deposited onto the carded fiber web 30 through controlled release from hopper 20. This controlled particle feeding ensures even distribution of aerogel particles across fiber web 30. Preferably, the aerogel loading rate is adjusted to achieve the target composition of 70-80% aerogel by weight in the final composite.

Next, as seen in FIG. 2, the aerogel-embedded fiber web is cross-lapped back and forth on top of itself to make a layered aerogel-embedded fiber web. The crosslapper 50 moves the fiber web 30 back and forth, layering it onto itself in a preferred overlapping, zigzag pattern. This process creates a sandwich structure with multiple layers of fiber web interspersed with aerogel particles. This overlapping technique ensures that aerogel particles are encapsulated within the fiber layers, promoting uniform particle distribution, and enhancing composite integrity.

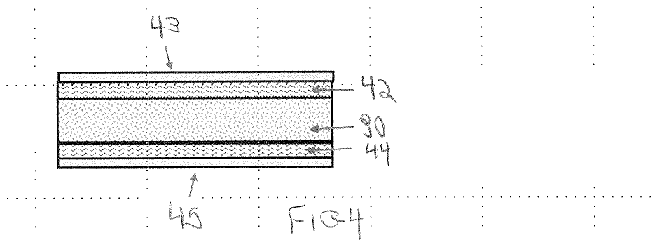

Next, as seen in FIG. 3, the layered (i.e.: now cross-lapped) aerogel-embedded fiber web 30 may be passed through a belt press 60 to compress the layered aerogel-embedded fiber web into a stable compressed composite. Specifically, belt press 60 comprises a heated upper belt 62 and a heated lower belt 64 moved by rollers 66. The cross-lapped fiber web 30 is passed between heated belts 62 and 64.

At this time, a first aerogel-free fiber web 42 may be placed on top of the stable compressed composite and a second aerogel-free fiber web 44 may be placed underneath the stable compressed composite. Preferably, the first and second aerogel-free fiber webs 42 and 44 are thermo-pressed onto the stable compressed composite web 30. The first and second aerogel-free fiber webs 42 and 44 may optionally be made from mineral or glass fibers or from a high-performance polymer including an aramid. The belt press 60 applies controlled pressure to the layered structure, compressing the fibers and aerogel particles into a stable composite. This pressing action achieves the desired thickness and density while securing the aerogel particles within the fiber web matrix.

Preferably, belts 62 and 63 are heated. As such, the compressed composite (42/30/44) may undergo a thermal bonding process to further secure the fibers and enhance structural integrity. This step can be achieved by applying mild heat through the belt press or an external heating source, softening the fibers slightly to help bind the composite layers. This step can also be known as a melt press. If thermal bonding is used, temperatures should be carefully controlled to prevent melting of the aerogel particles while achieving fiber bonding.

Finally, FIG. 4 illustrates a close-up sectional elevation view of the structure of the layered composite web 30 positioned between the aerogel-free fiber webs 42 and 44 which may in turn be disposed between a top facer 43 and bottom facer 45. The first and second facers 43 and 45 are preferably adhered to the first and second aerogel-free fiber webs 42 and 44, respectively. The first and second facers 43 and 45 may optionally be made from craft paper, polypropylene, PET, polycarbonate, polyethylene, polyurethane, PVC, or an aramid.

The final composite product then exits belt press 60, where it is cut to size or rolled up for storage and transport. The resulting composite material has a high concentration of aerogel particles (70-80%) for enhanced insulation, with a fiber matrix providing structural stability.

In preferred aspects of the present method, the following process control and optimization steps can be included: (a) Aerogel Feeding Control: To ensure consistency, the hopper system may be calibrated to control the rate and distribution of aerogel particles onto the fiber web; (b) Crosslapping Layer Count: The number of layers created during crosslapping can be adjusted to control the thickness and mechanical properties of the final composite; and (c) Pressing Parameters: The pressure applied in the belt press is preferably adjusted to ensure proper consolidation without excessive compaction, maintaining the aerogel's insulating properties.

Advantages of the present preferred method may include: (a) High Aerogel Content: This method enables a high loading of aerogel (70-80% by weight), which significantly enhances the thermal insulation properties of the composite; (b) Structural Integrity: The cross-lapping and pressing steps ensure that the aerogel particles are well-integrated and that the composite has adequate structural support; (c) Scalability: This continuous method is designed for industrial scalability, utilizing established carding, layering, and pressing technologies; and (d) Versatile Composite Structure: The process allows for adjustable fiber-to-aerogel ratios and thickness, enabling customization for specific applications.

What is claimed is:

1. A method of making an aerogel insulation material for use in building insulation, comprising:
producing a supply of short fibers having aerogel particles attached thereto;
providing a continuously moving fiber web;
depositing the short fibers having aerogel particles attached thereto onto the continuously moving fiber web to produce an aerogel-embedded fiber web;
crosslapping the continuously moving aerogel-embedded fiber web back and forth on top of itself to produce a layered aerogel-embedded fiber web;
passing the layered aerogel-embedded fiber web through a belt press to compress the layered aerogel-embedded fiber web into a stable compressed composite; and then cutting or rolling the stable compressed composite into desired sizes.

2. The method of claim 1, further comprising:
heating the stable compressed composite prior to cutting or rolling the stable compressed composite into desired sizes.

3. The method of claim 1, wherein the continuously moving fiber web is supplied by a carding machine and the aerogel particles are deposited by a hopper.

4. The method of claim 1, wherein the aerogel particles comprise 70% or more of the weight of the aerogel-embedded fiber web.

5. The method of claim 4, wherein the aerogel particles comprise 70% to 80% of the weight of the aerogel-embedded fiber web.

6. The method of claim 1, wherein the short fibers are 10-200 mm in length.

7. The method of claim 1, wherein the short fibers are made of glass or polymer.

8. The method of claim 1, further comprising:
placing a first aerogel-free fiber web on top of the stable compressed composite; and
placing a second aerogel-free fiber web underneath the stable compressed composite.

9. The method of claim 8, wherein the first and second aerogel-free fiber webs are thermo-pressed onto the stable compressed composite.

10. The method of claim 8, wherein the first and second aerogel-free fiber webs are made from mineral or glass fibers or from a high-performance polymer including an aramid.

11. The method of claim 8, further comprising:
placing a first facer on top of the first aerogel-free fiber web; and
placing a second facer underneath the second aerogel-free fiber web.

12. The method of claim 11, wherein the first and second facers are adhered to the first and second aerogel-free fiber webs, respectively.

13. The method of claim 11, wherein the first and second facers are made from craft paper, polypropylene, PET, polycarbonate, polyethylene, polyurethane, PVC, or an aramid.

14. The method of claim 1, wherein the fiber web is made from polymer-based fiber.

15. The method of claim 14, wherein the polymer-based fiber is made of polypropylene, PET, polyethylene.

16. The method of claim 1, wherein the supply of short fibers having aerogel particles attached thereto are produced by a sol-gel process.

17. The method of claim 1, wherein the aerogel particles are in a powdered form.

18. The method of claim 1, wherein the aerogel particles are a silica aerogel, a zirconia oxide aerogel, or a silica carbide aerogel.

19. The method of claim 1, wherein the supply of short fibers having aerogel particles attached thereto further comprises a low density/lightweight binder.

20. The method of claim 1, wherein the supply of short fibers having aerogel particles attached thereto further comprises a flame retardant.
